(19) United States
(12) Patent Application Publication
(10) Pub. No.: US 2015/0308926 A1
(43) Pub. Date: Oct. 29, 2015

(54) VIBRATION ANALYSIS METHOD AND VIBRATION ANALYSIS DEVICE OF VEHICLE

(71) Applicant: TOYOTA JIDOSHA KABUSHIKI KAISHA, Toyota-shi, Aichi-ken (JP)

(72) Inventor: Shingo KOUMURA, Susono-shi (JP)

(73) Assignee: TOYOTA JIDOSHA KABUSHIKI KAISHA, Toyota-shi, Aichi-ken (JP)

(21) Appl. No.: 14/654,674

(22) PCT Filed: Jan. 23, 2013
(86) PCT No.: PCT/JP2013/051266

§ 371 Date: Jun. 22, 2015

(51) Int. Cl. G01M 17/04; G01N 29/44

(52) U.S. Cl. CPC G01M 17/04; G01N 29/44; G01N 2291/023

(57) ABSTRACT

There is provided a vibration analysis technique using vibration measured while a vehicle is made to run on a real road, enabling the detection of vibration characteristics while distinguishing various vibrational input modes. In the inventive vibration analysis technique, a vehicle is made to run on a road surface whose height varies at various wavelengths along its movement, and using a vibration characteristic value in a site of a vehicle body measured during the vehicle running as a response variable and using at least two vibration input values causing the vibration characteristic value as explanatory variables, a transfer function of the vibration characteristic value for each of at least two vibration input values is computed as partial regression coefficients by multiple regression analysis.

### TECHNICAL FIELD

This invention relates to a vibration analysis method or a vibration analysis device for analyzing vibration generated in a vehicle, such as an automobile, and more specifically to a device or a method for analyzing a transmission characteristic of vibration inputted from a road surface into a vehicle.

### BACKGROUND ART

In a vehicle, such as an automobile, its riding comfort performance depends on the transmission characteristics of vibration given from a road surface to a vehicle body during the running of the vehicle. Then, in order to grasp the characteristics of vibration transmitted from a road surface to a vehicle body for the purpose of the improvement of the riding comfort performance of a vehicle, there have been already proposed various vibration analysis methods or vibration analysis devices for conducting measurements and analyses of vibration generated in a vehicle body to detect the characteristics of vibration transmitted from a road surface to the vehicle body. For such vehicle vibration analysis methods, for example, as illustrated in patent document 1, there have been proposed a method and/or a device in which vibration characteristics of a vehicle body are detected by placing a vehicle such that its wheels are put on a table which vibrates up and down and/or left and right (a vibrating table) and performing measurements and analyses of accelerations generated in a vehicle body when the table is being vibrated. Further, in patent document 2 and non-patent document 1, there have been proposed a vibration analysis method and device to detect vibration characteristics of a vehicle body by placing four wheels of a vehicle on separate vibrating tables, each of which can vibrate the corresponding wheel individually, and applying vibration from the wheels to the vehicle body. In this document, it has been shown that the frequency characteristics of transfer functions are acquired based upon acceleration variations, grounding load variations on ground contact surface (between the vibrating tables and wheels) and/or suspension strokes, measured at various sites in the vehicle body when various modes of vibration inputs (random wave input, front-rear and right-left wheel inphase wave inputs, antiphase wave inputs, etc.) are applied to the four wheels, and thereby, contributions of influences of respective components, such as a suspension, a vehicle body and a seat, on the vibration characteristics of the vehicle body can be individually detected.

### PRIOR TECHNICAL DOCUMENTS

### Patent Documents

Patent document 1: Japanese Patent laid-open publication No. 2000-88697
Patent document 2: Japanese Patent laid-open publication No. 2009-97973

### Non-Patent Documents

Non-patent document 1: “Ride comfort analysis considering body and seat system”, Iguchi, et al., Public Interest Incorporated Association—The Society of Automotive Engineers of Japan, Inc. (JSAE) Academic Meeting Preprint Collection, October, 2007 no. 104-07, p 13-p 18, Document number 20075771

### SUMMARY OF INVENTION

### Technical Problem

According to vibration analysis techniques to detect a vibration characteristic of a vehicle by applying vibration displacement inputs D from respective wheels to a vehicle body individually in various arbitrary manners in the vehicle placed on a vibrating table V and measuring vibration Y generated in the vehicle body as illustrated schematically in FIG. 9 (A), it is possible to detect a vibration characteristic resulting from the vibration from the respective front and rear, left and right wheels and/or the difference in vibration characteristics depending upon various vibration modes in front and rear wheels or left and right wheels (an inphase input, an antiphase input), and therefore, advantageous information in improvements of vehicle body structures, etc. for the riding comfort performance improvement can be obtained. However, according to researches by the inventor of the present invention, it has been found that, in a case of a vibration analysis of a vehicle performed on a vibrating table as described above, vibrational conditions obtained in making a vehicle run on a real road are not always reproducible. For instance, as illustrated in FIGS. 9(B)-(F), in vibrational frequency characteristics (“vibrating”) obtained in applying to a vehicle on a vibrating table vibrations in the longitudinal direction, vertical direction, horizontal direction, yaw direction, rolling direction and pitch direction, it has been revealed that there occur certain “gaps” from the vibrational frequency characteristics obtained in a vehicle running on a real road (“Real Running”) as indicated with arrows in the drawings. It is considered that such “gaps” are caused because the wheels are not rotating on the vibrating table so that vibration transmission conditions in a vehicle running on a real road cannot be reproduced precisely.

Therefore, it can be said that, in order to detect a vibration transmission characteristic of a vehicle body more precisely, it is preferable to perform a vibration measurement while making a vehicle run on a real road. However, in the case of the detection of a vibration characteristic of a vehicle body performed in a vehicle running on a real road in the past, it is performed just to compute a vibration frequency characteristic from vibration measured when a vehicle is made to run on a certain road surface, and thus, it has not been achieved to detect individual or separate contributions of various vibration inputs in a vibration characteristic. This is because, when a vehicle is made to run on a real road, usually, the front wheel and rear wheel pass through the almost same route, and thus, it is difficult to apply vibration to the front and rear wheels independently so that contributions of the respective front and rear wheels cannot be easily separated in the detected vibration characteristic.

Accordingly, one of the main objects of the present invention is to propose a structure of a vibration analysis technique using vibration measured by making a vehicle run on a real road, in which vibration characteristics resulting from various modes of vibration inputs can be detected individually or separately.

### Solution to Problem

According to the present invention, the above-mentioned object is achieved by a vibration analysis method of a vehicle, the method comprising steps of: making the vehicle run on a road surface whose height varies at various wavelengths along the moving direction of the vehicle; measuring a vibration characteristic value in a site of a vehicle body of the vehicle running on the road surface; acquiring at least two vibration input values causing the vibration characteristic value in the site of the vehicle body; and computing a transfer function of the vibration characteristic value in the site of the vehicle body for each of the at least two vibration input values as a partial regression coefficient by multiple regression analysis using the vibration characteristic value in the site of the vehicle body as a response variable and using the at least two vibration input value as explanatory variables.

In the above-mentioned structure, the “vibration characteristic value in a site of a vehicle body” may be an arbitrary physical quantity, such as an acceleration value, indicating a vibration characteristic of an arbitrary site in a vehicle body, and for instance, it may be a sprung mass acceleration value, an unsprung mass acceleration value at each wheel, etc., measured with an arbitrary detector, e.g. an accelerometer. Further, “at least two vibration input values” may be arbitrary vibrational components which are transmitted to the vehicle body and cause the above-mentioned vibration characteristic value. Typically, these may be road surface displacements of respective wheels or their functions during the running of the vehicle, or may be unsprung mass acceleration values at the respective wheels, etc. (In this case, the vibration characteristic value may be the sprung mass acceleration value in the downstream of the vibration transmission, etc.). In one embodiment, the at least two vibration input values may be, for instance, a group of vibrationally varying physical quantities comprising vibrational components of four modes consisting of a road surface displacement component varying in the same phase at the left and right front wheels, a road surface displacement component varying in the same phase at the left and right rear wheels, a road surface displacement component varying in the opposite phase at the left and right front wheels and a road surface displacement component varying in the opposite phase at the left and right rear wheels. Although the vibration input values may be values directly measured with arbitrary sensors, it may be values computed from arbitrary measured values.

In the above-mentioned vibration analysis method of a vehicle of the present invention, as noted above, first, a vehicle whose vibration characteristic is to be inspected is made to run on a road surface whose height varies at various wavelengths along the moving direction of the vehicle. Then, vibrations of various frequencies and phases, determined by the wavelengths of the road surface displacements and the vehicle speed, are transmitted to respective parts in the vehicle body through the wheels. Under a condition that the vehicle is made to run in such a way, measurements of the vibration characteristic value in an arbitrary site of the vehicle body and acquisitions of the at least two vibration input values (measurement and/or calculation of road surface displacements or measurement of unsprung mass acceleration values, etc.) are performed in time series. Here, since the at least two vibration input values and vibration characteristic value, having been measured or acquired, are in a relation between explanatory variables (independent variables) and a response variable (dependent variable), it is possible to detect a transfer function of the vibration characteristic value for each of the at least two vibration input values by the theory of the multiple regression analysis. Further, those transfer functions indicate vibration transmission characteristics in the arbitrary site of the vehicle body corresponding to the respective vibration input values, and therefore, by means of those transfer functions, it becomes possible to detect or grasp a vibrational frequency characteristic of the vehicle in providing an arbitrary vibrational input, such as a road surface displacement and unsprung mass acceleration value, for each kind of the vibrational input.

In this regard, in the above-mentioned vibration analysis method of a vehicle according to the present invention, preferably, in the step of making the vehicle to run on the road surface whose height varies at various wavelengths along the moving direction of the vehicle, the measurement of a vibration characteristic value and the acquisition of at least two vibration input values may be performed while the vehicle is made to run at different speeds. As noted above, in a case of detecting the respective transfer functions of the vibration characteristic value for the at least two vibration input values by means of the theory of the multiple regression analysis, it is preferable that vibration of various combinations of frequencies and phases as much as possible is given to the front and rear wheels. The frequencies and phases of the vibrations given to the front wheels and the rear wheels are determined based on the wavelengths of displacements in the road surface, the vehicle speed and the distance between the front and rear wheels, and therefore, even when the vehicle is made to run on the same road surface, vibrations of different frequencies and phases will be given to the front wheels and the rear wheels if the vehicle is made to run at different vehicle speeds, and thus, the accuracies and frequency resolutions of the transfer functions will be improved. Furthermore, with respect to the road surface on which the vehicle is made to run, it is preferable that the road surface displacements are prepared to have various combinations of wavelengths and phases as much as possible in order to give vibrations of various combinations of frequencies and phases as much as possible to the front wheels and the rear wheels. Thus, concretely, the road surface on which the vehicle is made to run may be a road surface whose height varies at random or stepwise.

As noted above, when the respective transfer functions of the vibration characteristic value for the at least two vibration input values have been computed, the vibrational amplitude of the vibration characteristic value to be generated by each vibration input value can be computed with the corresponding transfer function. Thus, the above-mentioned inventive method may further comprise a step of computing a vibrational amplitude of the vibration characteristic value in the site of the vehicle body caused by one of the at least two vibration input value using the one of the at least two vibration input value and the transfer function corresponding thereto. The obtained vibrational amplitude of the vibration characteristic value which each vibration input value generates will become advantageous information in performing modifications, etc. of the structure of the vehicle body, etc. in order to improve the vibration characteristic of the vehicle body.

Moreover, when transfer functions in a vehicle having run on a certain road surface have been obtained, it becomes possible to estimate a vibration characteristic value in the vehicle when it is made to run on an arbitrary different road surface (Conversion to a vibration characteristic on a different road surface). Furthermore, by means of the transfer functions, it will also become possible to estimate a vibration characteristic value in the vehicle when it is made to run at an arbitrary vehicle speed (Conversion to a vibration characteristic at a different vehicle speed). Thus, in the above-mentioned inventive method, there may be performed a step of estimating, by means of the transfer functions, a vibration characteristic value in the site of the vehicle body to be obtained when the vehicle is made to run on a different road surface than the road surface on which the vehicle was made to run when the measurement of the vibration characteristic value in the site of the vehicle body and the acquisition of the vibration input values used for calculation of the transfer functions were performed, and/or, a step of estimating, by means of the transfer functions, a vibration characteristic value in the site of the vehicle body to be obtained when the vehicle is made to run at a different speed than the speed at which the vehicle was made to run when the measurement of the vibration characteristic value in the site of the vehicle body and the acquisition of the vibration input values used for calculation of the transfer functions were performed.

The series of the above-mentioned manners of the inventive vibration analysis method may be achieved by a vibration analysis device which is designed to compute a transfer function of a vibration characteristic value in a site of a vehicle body for each of at least two vibration input values. Thus, according to the present invention, there is provided a vibration analysis device of a vehicle, the device comprising a vibration characteristic value measurement portion which measures a vibration characteristic value in a site of a vehicle body of the vehicle during making the vehicle to run on a road surface whose height varies at various wavelengths along the moving direction of the vehicle; a vibration input value acquisition portion which acquires at least two vibration input values causing the vibration characteristic value in the site of the vehicle body; and a transfer function computation portion which computes a transfer function of the vibration characteristic value in the site of the vehicle body for each of the at least two vibration input values as a partial regression coefficient by multiple regression analysis using the vibration characteristic value in the site of the vehicle body as a response variable and using the at least two vibration input value as explanatory variables. The vibration characteristic value measurement portion may be, for example, an accelerometer, etc., provided on the arbitrary site of the vehicle body. Further, the vibration input value acquisition portion may be constructed from, for example, a road surface displacement detection sensor provided in the undersurface of the vehicle, or a road surface displacement detection sensor and accelerometers provided under springs of the respective wheels, or a calculation device appropriately computing the vibration input values using the output values of those sensors, etc. The transfer function computation portion may be a calculation device which is capable of computing a transfer function by multiple regression analysis from the vibration characteristic value and vibration input values.

### Effect of Invention

Generally, in accordance with the above-mentioned present invention, in a vibration analysis of a vehicle, since the analyzing of a vibration transmission characteristic in a vehicle is performed with a vibration characteristic value measured during the vehicle running on a real road, the information on the vibration characteristic will be acquired under a condition that wheels are rotating, and thus, the vibration analysis becomes possible under a condition which is not satisfactorily reproducible in the vibration analysis using a vibrating table. Also, according to the present invention, through computing a transfer function of a vibration characteristic value in a site of a vehicle body for each of at least two vibration input values, the magnitude of contribution of each vibration input value in a vibration transmission characteristic in a vehicle can be detected. Further, according to this structure, the grasp of vibration characteristics while distinguishing various vibrational input modes, which could be performed only in the vibration analyses using a vibrating table in the past, will also become possible. Namely, according to the present invention, the detection of vibration characteristics of a vehicle body corresponding to various vibrational input modes or the detection of the difference in vibration characteristics of a vehicle body depending upon vibrational input modes will become possible under vibrational conditions which have not been reproducible in the vibration analysis using a vibrating table. Thus, it is expected that the information about vibration characteristics in a vehicle which has become acquirable in the present invention will be advantageously used in improvements of a vehicle and the grasp of vibrational conditions of a vehicle under various running conditions for the improvements of the riding comfort performances.

Other purposes and advantages of the present inventions will become clear by explanations of the following preferable embodiments of the present invention.

### BRIEF DESCRIPTIONS OF DRAWINGS

FIG. 1 (A) is a typical side view of a vehicle equipped with a device for performing a vibration analysis in accordance with the present invention, and FIG. 1 (B) is a block diagram of the structure of the device performing the vibration analysis.

FIGS. 2 (A) and (B) are drawings explaining about frequencies of vibrations caused in a vehicle in performing a vibration analysis in accordance with the present invention.

FIG. 3 is schematic diagrams explaining about the shapes of roads on which a vehicle is made to run in a vibration analysis in accordance with the present invention.

FIG. 4 (A) shows frequency characteristics of gains and phases of examples of transfer functions of sprung mass and unsprung mass accelerations for front wheel inphase inputs computed in a vibration analysis in accordance with the present invention. FIG. 4 (B) shows frequency characteristics of gains and phases of examples of transfer functions of sprung mass and unsprung mass accelerations for rear wheel inphase inputs computed in a vibration analysis in accordance with the present invention.

FIGS. 5 (A)-(D) show frequency characteristics of amplitudes of sprung mass longitudinal accelerations in each vibration input mode computed with the transfer functions computed in a vibration analysis in accordance with the present invention. “After Change” indicate the frequency characteristics in a case that the arrangement of rear suspensions, seen in the side view, was changed from that of “Before Change” in a vehicle.

FIGS. 6 (A)-(D) show frequency characteristics of amplitudes of sprung mass lateral accelerations in each vibration input mode computed with the transfer functions computed in a vibration analysis in accordance with the present invention. “After Change” indicate the frequency characteristics in a case that the arrangement of front suspensions, seen in the back view, was changed from that of “Before Change” in a vehicle.

FIGS. 7 (A)-(C) show examples in which, with transfer functions computed from the data measured on a certain road surface, vibration characteristics (amplitudes of sprung mass accelerations) to be generated on the other road surface were computed in a vibration analysis in accordance with the present invention. For the purpose of the comparison, the vibration characteristics actually measured on the other road surface are also shown.

FIGS. 8 (A)-(C) show examples in which, with transfer functions computed from the data measured on a certain road surface, vibration characteristics (amplitudes of sprung mass accelerations) to be generated on the other road surface were computed in a vibration analysis in accordance with the present invention. In this case, in the computation of transfer functions, the measured values of unsprung mass acceleration were used as vibration input values, instead of road surface displacements. For the purpose of the comparison, the vibration characteristics actually measured on the other road surface are also shown.

FIG. 9 (A) is a schematic drawing of a device measuring a vibration characteristic of a vehicle using a conventional vibrating table. FIGS. 9 (B)-(F) are frequency spectra of vibrations of the vertical acceleration, pitch angle acceleration, roll angle acceleration, lateral acceleration and longitudinal acceleration, respectively, of a vehicle, measured using the vibrating table (Vibrating). For the purpose of the comparison, there are also shown frequency spectra of the corresponding accelerations obtained when the vehicle was actually made to run (Real Running). In the drawings, the arrows indicate regions in which gaps are large between the frequency spectra in the vibration measurements with the vibrating tables and the frequency spectra in the vibration measurements in the real running.

### EXPLANATIONS OF REFERENCE NUMERALS

1—Vehicle
2f, 2r—Wheels
3—Vehicle body
10—Displacement gage
12—Vertical accelerometer
14 f, r,—unsprung mass accelerometer
16—Sprung mass accelerometer

### DESCRIPTION OF EMBODIMENTS

In the followings, preferable embodiments of the present invention are described in detail with reference to the drawings.

### Structure of Vibration Analysis Device

In one embodiment of the vibration analysis technique of a vehicle in accordance with the present invention, briefly, there are measured sequentially values indicating vibrations inputted into a vehicle body, such as road surface displacements, and a value indicating a vibration characteristic of an arbitrary site of the vehicle body, such as an acceleration value, in a vehicle during running on a road surface whose height varies at various wavelengths. Then, based upon vibration input values computed from the road surface displacement values and/or the acceleration values (unsprung mass) and the vibration characteristic value of the measured acceleration value, etc., there are computed transfer functions of the vibration characteristic value (the acceleration value) for the vibration input values, and by means of the computed transfer functions, there are conducted computation of vibration levels (a frequency characteristics of the vibrational amplitudes) of the arbitrary site of the vehicle body for the vibration input values, and estimation of a vibration level under an arbitrary road surface condition or vehicle speed condition.

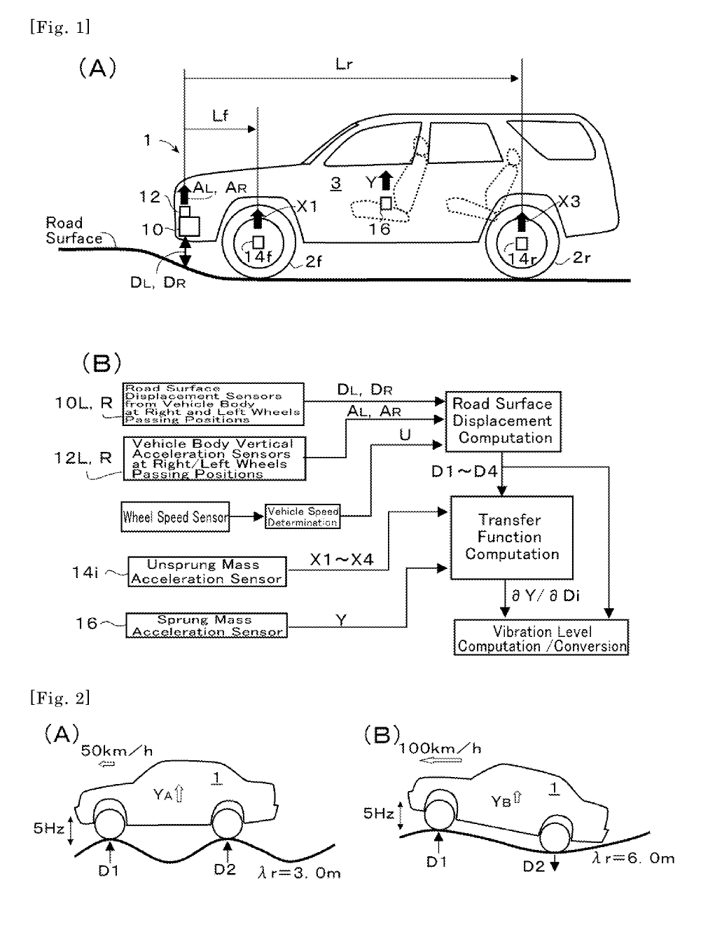

Referring to FIG. 1 (A), in the vibration analysis device in accordance with the present invention, first, as illustrated, there are provided an accelerometer 16 which measures an acceleration value Y of an arbitrary site above springs, such as a body floor, a seat, a suspension tower, of vehicle 1 such as automobile, during its running, and/or accelerometers 14f, r which measure acceleration values X1-X4 of arbitrary sites under the springs, such as wheel axles (The unsprung mass acceleration value may be measured for each wheel.). In this regard, the direction of the measured acceleration may be an arbitrary direction, such as the longitudinal, vertical, lateral, rolling, yawing, pitching direction, etc. of the vehicle body. Further, in order to detect road surface displacements in the passing routes of the left and right wheels of the vehicle 1, sensors 10, such as laser displacement gages, etc., which measure road surface height displacements D_{L} and D_{R} from the vehicle body, are provided to the sites in front of left and right wheels in the vehicle body, and accelerometers 12 which measure vertical acceleration values A_{L} and A_{R} in the measurement sites of the sensors 10 (left and right wheel passing position vertical acceleration values) are provided.

Then, the measured acceleration values Y, X1-4, A_{L}, A_{R} and/or road surface displacement values D_{L}, and D_{R} are inputted into a calculation device, not illustrated, and are used for the calculation of transfer functions. FIG. 1 (B) is a drawing showing the structure inside a calculation device in the form of a block diagram. With reference to the drawing, in the calculation device, concretely, the road surface displacement values D_{L}, D_{R}, and the left and right wheel passing position vertical acceleration values A_{L}, A_{R} are given to a road surface displacement computation portion together with a vehicle speed U. In the road surface displacement computation portion, there are computed a group of vibration displacements, generated at the respective wheels of the vehicle corresponding to the road surface displacements, or, as explained later, an arbitrary type of vibration displacements which are given from the road surface to the wheels and cause vehicle body vibrations, such as a group of a displacement which vibrates in the same phase at the left and right front wheels (left and right front wheel inphase input), a displacement which vibrates in the same phase at the left and right rear wheel (left and right rear wheel inphase input), a displacement which vibrates in the opposite phase at the left and right front wheel (left and right front wheel antiphase input) and a displacement which vibrates in the opposite phase at the left and right rear wheel (left and right rear wheel antiphase input). In one embodiment of the present invention, these vibration displacements at the wheels corresponding to the road surface displacements become vibration input values which cause vibration generated in the vehicle body. In this regard, the vehicle speed U may be determined or computed in an arbitrary manner from wheel velocity values measured with wheel speed sensors provided at the respective wheels, not illustrated. Then, the vibration displacements computed by the road surface displacement computation portion are given together with the unsprung mass acceleration values X1-X4 or the sprung mass acceleration value Y, to a transfer function computation portion, where, as described in detail, transfer functions of the acceleration value for the respective vibration input values are computed according to the theory of multiple regression analysis. Furthermore, the computed transfer functions and vibration inputs are given to a vibration level computation and conversion portion, where there will be performed computation of vibration levels caused by the respective vibration inputs and estimating calculation of vibration levels to be generated in various road surface conditions or vehicle speed conditions, etc.

In this regard, the calculation device may be a computer of an arbitrary form, and it should be understood that each portion illustrated in FIG. 1 (B) is realized by the processing operation of CPU and other members according to programs previously memorized in a storage device, such as a memory, in the computer.

### The Principle of Vibration Analysis

In the vibration analysis of a vehicle in the present invention, there is used a model in which the vibration of a vehicle body is caused by two or more displacement components of a road surface given to wheels, namely, a linear model in which, using road surface displacement components Di as input components, the vibration Y of a vehicle body is given by:

Y=a1·D1+a2·D2+a3·D3+a4·D4+ . . . (1)

[Here, ai is a transfer function (∂Y/∂Di) of the vibration Y for the input component Di. Expression (1) is an expression of the vibration Y and the displacement components Di in the frequency domain.] Accordingly, when the transfer functions (∂Y/∂Di) of the vibration Y for the input components Di in Expression (1) are determined, it becomes possible to compute the vibration Y of the vehicle body for an arbitrary road surface displacement component. Further, when the transfer functions are determined for the respective input components, it will become possible to estimate the contributions of each vibration input component in the vibration Y of the vehicle body, and this information becomes advantageous in considering the ways for the improvement of the riding comfort performance of the vehicle. In this connection, the vibration Y may be a vibration in an arbitrary direction of an arbitrary site in the vehicle body, namely, it may be a vibration in an arbitrary direction, e.g. the longitudinal, vertical, lateral, rolling, yawing, pitching direction, etc., of an arbitrary site above or under springs in the vehicle body and typically, the vibration is measured in the unit of acceleration value, but, it should be understood that it is not limited thereto.

In principle, the transfer function (∂Y/∂Di) of the vibration Y in the above-mentioned expression (1) can be computed by measuring the vibration Y under various input conditions being given, and solving simultaneous equations of Expression (1). For example, with reference to FIG. 2, as shown in FIG. 2 (A), when a vehicle runs at a vehicle speed of 50 km/h, a vibration input of 5 Hz is given to front and rear wheels in the same phase by a road surface displacement component of wavelength λr=3.0 m, so that a vibration YA by those front and rear wheel inphase inputs will be obtained, and as in FIG. 2 (B), when a vehicle runs at a vehicle speed of 100 km/h, a vibration input of 5 Hz is given to front and rear wheels in the opposite phase by a road surface displacement component of wavelength λr=6.0 m, so that a vibration YB by those front and rear wheel inphase inputs will be obtained. Accordingly, in 5 Hz vibration inputs, two relational expressions for the vibration Y and the vibration inputs D1 and D2:

Y_{A}=(∂Y/∂D1)D1_{A}+(∂Y/∂D2)D2_{A} (2)

Y_{B}=(∂Y/∂D1)D1_{B}+(∂Y/∂D2)D2_{B}

are obtained, and thereby, it becomes possible to solve the two expressions with respect to (∂Y/∂D1) and (∂Y/∂D2) as simultaneous equations, so that the transfer functions (∂Y/∂D1) and (∂Y/∂D2) in the frequency of 5 Hz will be obtained. That is, through conducting vibration measurements while making a vehicle run on a road surface formed from combinations of displacements of a plurality of different wavelengths at various different vehicle speeds, two or more vibration data (groups of vibration Y and input components Di) in each frequency can be acquired so that the transfer function for each vibration input will be computed.

In this connection, it should be understood that the number and kinds of the road surface displacement components Di in Expression (1) may be arbitrarily determined, depending upon the structure of a vehicle. In a case of a typical four-wheeled vehicle, components to be assumed as road surface displacement components Di may be a group of displacements at front and rear, left and right wheels in the vertical direction, or a group of a left and right front wheel inphase input, a left and right rear wheel inphase input, a left and right front wheel antiphase input and a left and right rear wheel antiphase input. Further, the number of transfer functions, i.e. unknown quantities, in Expression (1) corresponds to the number of road surface displacement components Di, and therefore, preferably, the number of expressions in the simultaneous equations as in Expression (2) is equal to or more than the number of unknown quantities, i.e., the number of road surface displacement components Di. Thus, in the vibration measurement process mentioned later, in order to obtain groups of measurement data (Y, Di) of the number equal to at least the number of the displacement components Di of a road surface, it is preferable to conduct the running of a vehicle and vibration measurement under mutually different measurement conditions of the number equal to or more than the number of the road surface displacement components Di. For instance, in a case of making a vehicle run on a certain testing road surface, vibration measurements may be performed while a vehicle is made to run at mutually different speeds of the number equal to or more than the number of road surface displacement components Di.

### Vibration Analysis Processes

The vibration analysis in accordance with the present invention may be performed using the above-mentioned vibration analysis device as described in the followings.

### (a) Vibration Measurement Process

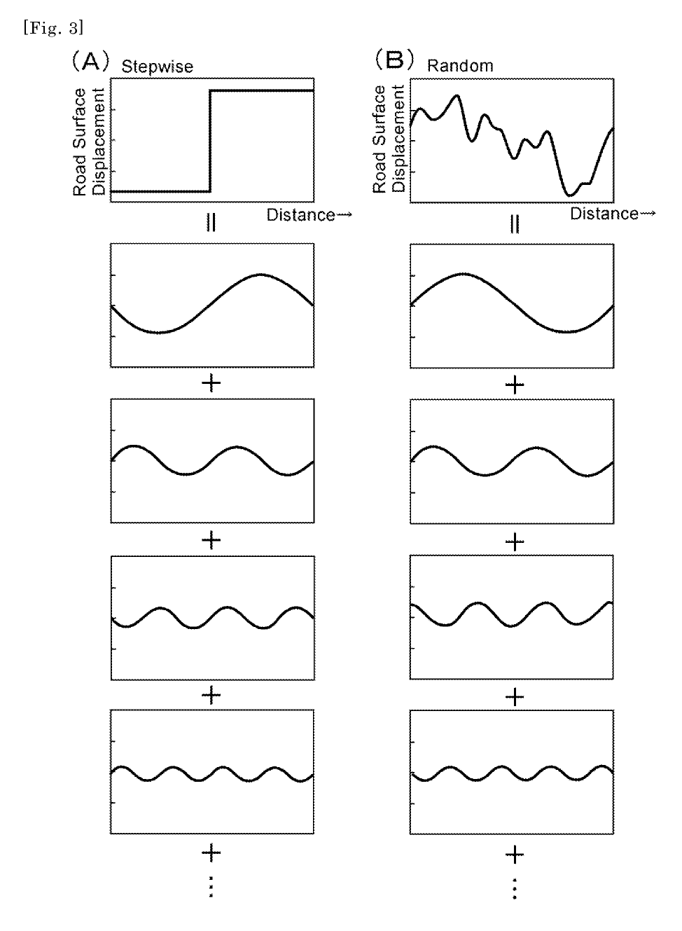

In the vibration measurement process of the vibration analysis in accordance with the present invention, as already noted, road surface height displacements D_{L}, D_{R}; acceleration values Y, X1-4 (vibration characteristic value) indicating a characteristic of vibration generated in a vehicle body; and acceleration values A_{L} and A_{R} (acceleration values used for computing vibration input values) are sequentially measured while a vehicle is made to run on a road actually. In the real road running of the vehicle for the vibration measurement, in order to acquire frequency characteristics of vibrations in as wide range as possible and as finely as possible, vibrations of different frequencies as much as possible should be inputted into the vehicle body during the running of the vehicle. Thus, the road for measurement (test course) is preferably so designed that the height of the road surface varies at different wavelengths as much as possible. Concretely, in one manner, as shown in FIG. 3 (A), there may be employed a road whose surface height varies stepwise. Since a stepwise displacement is made of combinations of displacements of many different wavelengths when it is decomposed into sinusoidal waves as illustrated, vibrations of many different frequencies will be inputted when a wheel passes over such a road surface. Further, as an alternative manner, as illustrated in FIG. 3 (B), there may be employed a road whose surface height varies at random, consisting of combinations of displacements of many different wavelengths. In this regard, such a random road is closer to a road surface on which a vehicle runs usually.

Furthermore, with respect to the running of a vehicle for the vibration measurement, as already noted, preferably, the vehicle is made to run at various different vehicle speeds in the vibration measurement being performed. In a case of making a vehicle run on a certain test course, when four road surface displacement components Di are assumed in Expression (1), supposing the right wheel displacement and the left wheel displacement, or the left and right inphase displacement and the left and right antiphase displacement, are independent from one another, the running of the vehicle and the vibration measurement are performed at two or more different vehicle speeds.

In this regard, the acceleration value data and road surface displacement value data, measured in the vibration measurement process, are converted into the data of the frequency domain by FFT conversion process. The following calculation processes are performed at each frequency s with values obtained through Laplace transform of the measurement data, in which the frequency s is used as the variable.

### (b) Computation of Vibration Input Values

As already noted, the vibration analysis of a vehicle in the present invention is performed based on the model in which the vibration Y of a vehicle body is generated owing to road surface displacement components Di at wheels as vibration input values, as in Expression (1). In a case of a four-wheeled vehicle, the road surface displacement components Di in the wheels may be a group of displacements in the vertical direction at front and rear, left and right wheels, or a group of a left and right front wheel inphase input, a left and right rear wheel inphase input, a left and right front wheel antiphase input and a left and right rear wheel antiphase input, etc. For instance, when the group of a left and right front wheel inphase input D1(s), a left and right rear wheel inphase input D2(s), a left and right front wheel antiphase input D3(s) and a left and right rear wheel antiphase input D4(s) is used as the vibration input values, the respective input values are computed out by using values obtained by Laplace transform, in which frequency s is used as the variable, of the road surface displacement values D_{L}, D_{R}, from the vehicle body, at the passing positions of the left and right wheels, and vertical acceleration values at the passing positions of the left and right wheels A_{L}, A_{R}, and the vehicle speed U, as follows:

$$\begin{matrix}[ Exp . 1 ] & \\ D 1 ( s ) = \frac{( {D}_{L} + \frac{{A}_{L}}{{s}^{2}} ) exp ( - \frac{Lf}{U} s ) + ( {D}_{R} + \frac{{A}_{R}}{{s}^{2}} ) exp ( - \frac{Lf}{U} s )}{2} & ( 3 ) \\ D 2 ( s ) = \frac{( {D}_{L} + \frac{{A}_{L}}{{s}^{2}} ) exp ( - \frac{Lr}{U} s ) + ( {D}_{R} + \frac{{A}_{R}}{{s}^{2}} ) exp ( - \frac{Lr}{U} s )}{2} & \\ D 3 ( s ) = \frac{( {D}_{L} + \frac{{A}_{L}}{{s}^{2}} ) exp ( - \frac{Lf}{U} s ) - ( {D}_{R} + \frac{{A}_{R}}{{s}^{2}} ) exp ( - \frac{Lf}{U} s )}{2} & \\ D 4 ( s ) = \frac{( {D}_{L} + \frac{{A}_{L}}{{s}^{2}} ) exp ( - \frac{Lr}{U} s ) - ( {D}_{R} + \frac{{A}_{R}}{{s}^{2}} ) exp ( - \frac{Lr}{U} s )}{2} & \end{matrix}$$

Here, Lf and Lr are the distances from the measurement positions of the road surface displacements to the front wheel axle and rear wheel axle, respectively. In Expression (3), and the first term and the second term of the numerators of the first expression and the third expression are the displacements of the left front wheel and right front wheels, respectively, and the first term and the second term of the numerators of the second expression and the forth expression are the displacements of the left rear wheel and right rear wheels, respectively. The above-mentioned vibration input values may be computed for each measurement data. For example, when the running of a vehicle and the vibration measurement are performed in a certain test course at the vehicle speeds of 30 km/h, 40 km/h, 50 km/h, 60 km/h and 70 km/h, the vibration input values D1 (s)-D4 (s) are computed using the road surface displacement values D_{L}, D_{R} from the vehicle body at the passing positions of the left and right wheels; the vertical acceleration values at the passing positions of the left and right wheels A_{L}, A_{R}, and the vehicle speed U for each trial.

### (c) Computation of Transfer Functions

Thus, when the data groups of vibration characteristic values Y(s) and vibration input values D1 (s)-D4 (s) are obtained (at more than the number of the vibration input values), transfer functions ∂Y/∂Di (s) of the vibration characteristic value Y (s) for the respective vibration input values Di (s) are computed in accordance with the theory of multiple regression analysis. Concretely, in the model in which the relation between the vibration characteristic value Y (s) and the vibration input values Di (s) is given by Expression (1), the transfer functions may be computed by the following expressions using the least-squares method of a plurality of variables.

$$\begin{matrix} [ Expression 2 ] & \\ ( \begin{matrix}\frac{\partial Y}{\partial D 1} ( s ) \\ \frac{\partial Y}{\partial D 2} ( s ) \\ \frac{\partial Y}{\partial D 3} ( s ) \\ \frac{\partial Y}{\partial D 4} ( s )\end{matrix} ) = {( \begin{matrix}\sum D 1 \cdot D {1}^{⋆} & \sum D 2 \cdot D {1}^{⋆} & \sum D 3 \cdot D {1}^{⋆} & \sum D 4 \cdot D {1}^{⋆} \\ \sum D 1 \cdot D {2}^{⋆} & \sum D 2 \cdot D {2}^{⋆} & \sum D 3 \cdot D {2}^{⋆} & \sum D 4 \cdot D {2}^{⋆} \\ \sum D 1 \cdot D {3}^{⋆} & \sum D 2 \cdot D {3}^{⋆} & \sum D 3 \cdot D {3}^{⋆} & \sum D 4 \cdot D {3}^{⋆} \\ \sum D 1 \cdot D {4}^{⋆} & \sum D 2 \cdot D {4}^{⋆} & \sum D 3 \cdot D {4}^{⋆} & \sum D 4 \cdot D {4}^{⋆}\end{matrix} )}^{- 1} \cdot ( \begin{matrix}\sum D {1}^{⋆} \cdot Y \\ \sum D {2}^{⋆} \cdot Y \\ \sum D {3}^{⋆} \cdot Y \\ \sum D {4}^{⋆} \cdot Y\end{matrix} ) & ( 4 )\end{matrix}$$

Here, Σ indicates the sum of the performed measurement data (For example, the measurement data of the running of a vehicle and vibration measurements which were performed at the vehicle speed of 30 km/h, 40 km/h, 50 km/h, 60 km/h and 70 km/h). Further, Di* is a conjugate complex number of Di. In Expression (4), for each frequency s, calculation is performed so that a transfer function ∂Y/∂Di (s) will be determined.

### (d) Computation of a Vibration Amplitude for Each Vibration Input Value

Thus, when transfer functions ∂Y/∂Di (s) are determined, the amplitude of the vibration Yi for each vibration input value Di will be computed by the following expression.

$$\begin{matrix}[ Expression 3 ] & \\ {\vert Yi ( s ) \vert}^{2} = {\vert \frac{\partial Y}{\partial Di} ( s ) \vert}^{2} \cdot {\vert Di ( s ) \vert}^{2} & ( 5 )\end{matrix}$$

According to the above-mentioned expression (5), the contribution from each vibration input value Di in the whole vibration Y will be grasped for each frequency s, and this information becomes advantageous in considering the ways for the improvement of the riding comfort performance of the vehicle.

(e) Estimation of Vibration Level Under Different Road Surface Condition and/or Different Vehicle Speed Condition

When the transfer functions are determined as described above, it becomes possible to perform estimation of the amplitude of a vibration level Y′ to be generated under any of road surface conditions and/or vehicle speed conditions, namely, a road surface condition and/or a vehicle speed condition different from the road surface condition or vehicle speed condition under which the vibration measurement has been performed (Conversion to a different road surface condition and/or a different vehicle speed condition). Concretely, the amplitude of a vibration level Y′ under an arbitrary road surface condition and/or an arbitrary vehicle speed condition is given by the following expression:

$$\begin{matrix} [ Expression 4 ] & \\ {\vert {Y}^{′} ( s ) \vert}^{2} = {\vert \frac{\partial Y}{\partial D 1} ( s ) + \frac{\partial Y}{\partial D 2} ( S ) exp ( - \frac{L}{U} s ) \vert}^{2} \cdot {\vert {Dp}^{′} ( s ) \vert}^{2} + {\vert \frac{\partial Y}{\partial D 3} ( s ) + \frac{\partial Y}{\partial D 4} ( s ) exp ( - \frac{L}{U} s ) \vert}^{2} \cdot {\vert {Do}^{′} ( s ) \vert}^{2} & ( 6 )\end{matrix}$$

Here, L is the distance between the front wheel axle and the rear wheel axle (wheel base), and U is an arbitrary vehicle speed. Dp′ (s) and Do′ (s) each are a road surface displacement component inputted in the same phase at left and right wheels and a road surface displacement component inputted in the opposite phase at left and right wheels on an arbitrary road surface. Thus, according to Expression (6), when frequency characteristics of displacement components under an arbitrary road surface have been acquired in an arbitrary way, the vibration Y to be generated when a vehicle would run on the arbitrary road surface can be predicted. According to this feature, when there is information about displacements of a road surface on which the running of a vehicle is expected, vibration to be generated in the vehicle can be predicted or estimated without the actual running of the vehicle, providing advantageous information in considering the ways for the improvement of the riding comfort performance of the vehicle on that expected road surface.

### (f) Computation of Transfer Functions Using Unsprung Mass Vertical Acceleration Values as Vibration Input Values

In the inventive vibration analysis, the transfer functions of the vibration Y can be computed using unsprung mass vertical acceleration values Xi at the respective wheels as the vibration input values instead of the road surface displacement components Di at the respective wheels, similarly to the above. Namely, assuming

Y=b1·X1+b2·X2+b3·X3+b4·X4 (7)

as a model corresponding to Expression (1) (bi is a transfer function (∂Y/θXi) of the vibration Y for the unsprung mass vertical acceleration value Xi.), similarly in Expression (4), the transfer functions of the vibration Y(s) for the unsprung mass vertical acceleration values Xi(s) at the respective wheels are given by the following expression:

$$\begin{matrix} [ Expression 5 ] & \\ ( \begin{matrix}\frac{\partial Y}{\partial X 1} ( s ) \\ \frac{\partial Y}{\partial X2} ( s ) \\ \frac{\partial Y}{\partial X 3} ( s ) \\ \frac{\partial Y}{\partial X 4} ( s )\end{matrix} ) = {( \begin{matrix}\sum X 1 \cdot X {1}^{⋆} & \sum X 2 \cdot X {1}^{⋆} & \sum X 3 \cdot X {1}^{⋆} & \sum X 4 \cdot X {1}^{⋆} \\ \sum X 1 \cdot X {2}^{⋆} & \sum X 2 \cdot X {2}^{⋆} & \sum X 3 \cdot X {2}^{⋆} & \sum X 4 \cdot {X2}^{⋆} \\ \sum X 1 \cdot X {3}^{⋆} & \sum X 2 \cdot X {3}^{⋆} & \sum X 3 \cdot X {3}^{⋆} & \sum X 4 \cdot X {3}^{⋆} \\ \sum X 1 \cdot X {4}^{⋆} & \sum X 2 \cdot X {4}^{⋆} & \sum X 3 \cdot X {4}^{⋆} & \sum X 4 \cdot X {4}^{⋆}\end{matrix} )}^{- 1} \cdot ( \begin{matrix}\sum X {1}^{⋆} \cdot Y \\ \sum {X2}^{⋆} \cdot Y \\ \sum X {3}^{⋆} \cdot Y \\ \sum X {4}^{⋆} \cdot Y\end{matrix} ) & ( 8 )\end{matrix}$$

Further, the amplitude of the vibration Yi by each unsprung mass vertical acceleration value Xi is computed by the following expression, similarly in Expression (5):

$$\begin{matrix}[ Expression 6 ] & \\ {\vert Yi ( s ) \vert}^{2} = {\vert \frac{\partial Y}{\partial Xi} ( s ) \vert}^{2} \cdot {\vert Xi ( s ) \vert}^{2} & ( 9 )\end{matrix}$$

Thus, according to the manner of computing the transfer functions of the vibration Y while using the above-mentioned unsprung mass vertical acceleration values, it becomes possible to grasp the magnitudes of the contributions of the vibration Y for the unsprung mass vertical acceleration values at the respective wheels without performing measurement of road surface displacement components.

Furthermore, the amplitude of vibration level Y′ under an arbitrary road surface condition and/or vehicle speed condition is given by the following expression:

$$\begin{matrix} [ Expression 7 ] & \\ {\vert {Y}^{′} ( s ) \vert}^{2} = {\vert \frac{\partial Y}{\partial X 1} \sqrt{{\vert X 1 \vert}^{2}} + \frac{\partial Y}{\partial X 2} \sqrt{{\vert X 2 \vert}^{2}} exp ( - \frac{L}{U} s ) \vert}^{2} \cdot \frac{{\vert {Dp}^{′} \vert}^{2}}{{\vert Dp \vert}^{2}} + {\vert \frac{\partial Y}{\partial X 3} \sqrt{{\vert X 3 \vert}^{2}} + \frac{\partial Y}{\partial X 4} \sqrt{{\vert X 4 \vert}^{2}} exp ( - \frac{L}{U} s ) \vert}^{2} \cdot \frac{{\vert {Do}^{′} \vert}^{2}}{{\vert Do \vert}^{2}} & ( 10 )\end{matrix}$$

Here, Dp(s) and Do (s) each are road surface displacement components inputted into the left and right wheels in the same phase and road surface displacement components inputted into the left and right wheels in the opposite phase on the road surface on which the vibration measurement has been performed.

### Experimental Examples

The validity of the present invention has been verified by performing experiments of computation of transfer functions and detection of vibration levels, etc. in accordance with the inventive vibration analysis method explained above. In this regard, it should be understood that the following embodiments illustrate the validity of the present invention only, not intended to limit the scope of the present invention.

### (a) Computation Examples of Transfer Functions

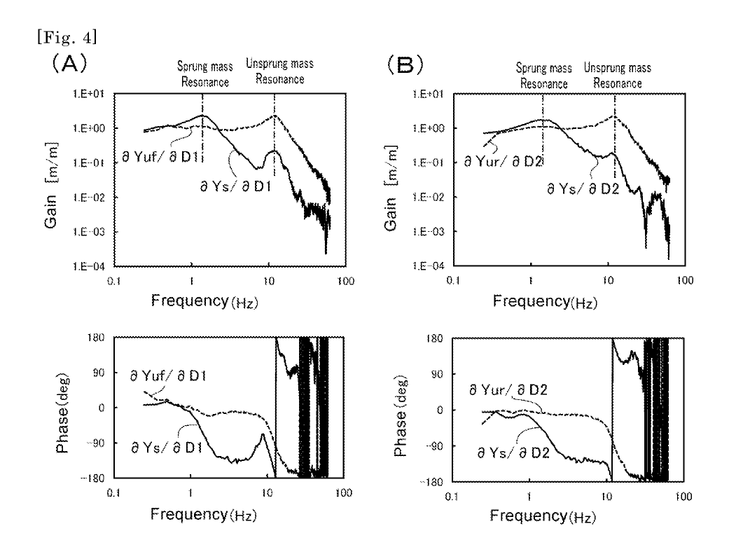

FIG. 4 shows examples of frequency characteristics of transfer functions of a sprung mass vertical acceleration value and transfer functions of an unsprung mass vertical acceleration value for road surface displacement components obtained by performing the running and vibration measurement of a four-wheeled vehicle on a test course at vehicle speeds of 30 km/h, 40 km/h, 50 km/h, 60 km/h and 70 km/h. The road surface displacement components were computed with Expression (3), and the transfer functions were computed with Expression (4). In the drawings, there are shown the gains and phases of a transfer function of a sprung mass acceleration for a front wheel inphase input, ∂Ys/∂D1; a transfer function of a front wheel unsprung mass acceleration for a front wheel inphase input, ∂Yuf/∂D1; a transfer function of the sprung mass acceleration for a rear wheel inphase input, ∂Ys/∂D2; and a transfer function of the front wheel unsprung mass acceleration for a rear wheel inphase input, ∂Yuf/∂D2, respectively. As understood with reference to the frequency characteristics of the gains in the drawings, a local maximum appeared at the sprung mass resonance frequency in the transfer function of the sprung mass acceleration while a local maximum appeared at the unsprung mass resonance frequency in the transfer function of the unsprung mass acceleration. The local maximum of the transfer function indicates that the vibration transmission reaches to its maximum at the frequency. This result suggests that, according to the inventive vibration analysis technique, it becomes possible to perform a stable detection of a transfer function, in which resonance points of sprung mass resonance and unsprung mass resonance, etc. of a vehicle can be detected.

### (b) Detection of Contribution to a Vehicle Body Vibration of Each Vibration Input Value

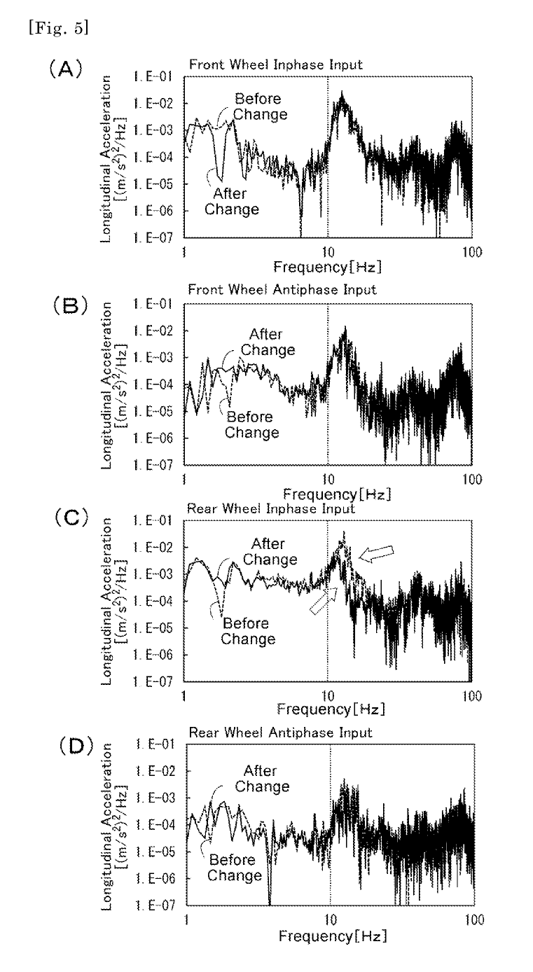

FIG. 5 shows examples in which, according to the inventive vibration analysis technique, after computing transfer functions of the longitudinal acceleration of a vehicle for respective road surface input components, the frequency spectrum of the vibration amplitude of the longitudinal acceleration was computed individually for each road surface input component. In this respect, the running of a vehicle and the vibration measurement were performed similarly in the case of FIG. 4. The road surface displacement components were computed with Expression (3), and the transfer functions were computed with Expression (4). Further, the vibration amplitude for each road surface input component was computed with Expression (5). In the drawings, values designated “Before Change” are values obtained in a test vehicle, and values designated “After Change” are values obtained after changing the arrangement of rear suspensions in the test vehicle in its side view. Especially with reference to (C) among the drawings, as shown by the arrows in the drawing, a significant difference was observed between “Before Change” and “After Change” in the frequency spectra of the amplitudes of vibrations by the rear wheel inphase inputs. This shows that the contribution to the vibration by the rear wheel inphase input has been changed by the arrangement change of the rear suspensions.

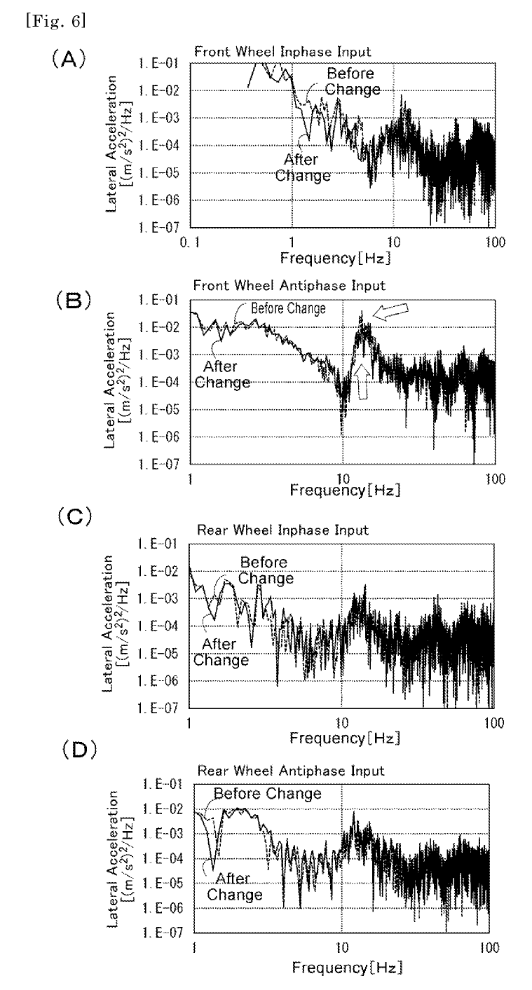

Furthermore, FIG. 6 shows examples in which, according to the inventive vibration analysis technique, after computing transfer functions of the lateral acceleration of a vehicle for respective road surface input components, the frequency spectrum of the vibration amplitude of the lateral acceleration was computed individually for each road surface input component. The running of the vehicle, the vibration measurement and the computation of frequency spectra of the vibration amplitudes were conducted similarly in the case of FIG. 5. In the drawings, values designated “Before Change” are values obtained in a test vehicle, and values designated “After Change” are values obtained after changing the arrangement of front suspensions in the test vehicle in its back view. Especially with reference to (B) among the drawings, as shown by the arrows in the drawing, a significant difference was observed between “Before Change” and “After Change” in the frequency spectra of the amplitudes of vibrations by the front wheel antiphase inputs. This shows that the contribution to the vibration by the front wheel antiphase input has been changed by the arrangement change of the front suspensions.

Thus, the results in FIG. 5 and FIG. 6 show that, according to the inventive vibration analysis technique, a contribution of each vibration input value in a vehicle body vibration can be detected individually, and that the influence of the contribution of each vibration input value in the vehicle body vibration by change of the structure in the vehicle body can be observed.

(c) Estimation of a Vibration Level Under an Arbitrary Road Surface Condition and/or an Arbitrary Vehicle Speed Condition

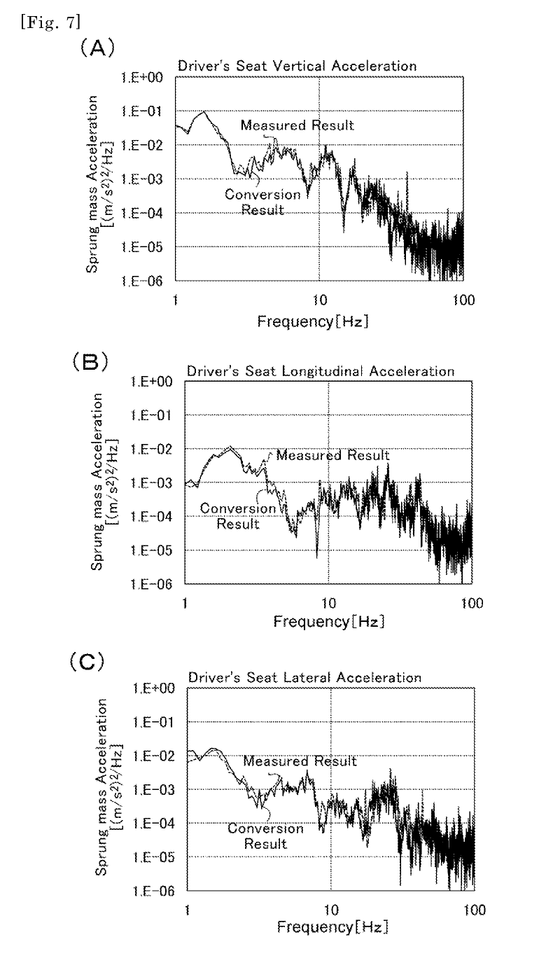

In accordance with the inventive vibration analysis technique, using transfer functions of vibrations for respective road surface displacement inputs computed with vibration data measured on a certain test course, vibration levels to be obtained when the vehicle would be made to run on the other road surface condition and vehicle speed condition were computed, and compared with vibration levels obtained when the vehicle was made to run actually on the other road surface condition and vehicle speed condition. The transfer functions were computed with Expressions (3) and (4) from the results obtained by performing the running of a vehicle at various vehicle speeds and vibration measurement in test course A. Then, vibration levels to be obtained in the running at a certain vehicle speed U in the other test course B were computed with Expression (6) using the computed transfer functions. FIG. 7 shows frequency spectra of vibrations of the vertical acceleration, longitudinal acceleration and lateral acceleration at a driver's seat to be obtained in the running at the vehicle speed U in test course B computed using the transfer functions obtained from the running of a vehicle and vibration measurement in test course A according to the inventive vibration analysis technique (“Conversion Result”); and frequency spectra of vibrations of the vertical acceleration, longitudinal acceleration and lateral acceleration at the driver's seat obtained when the vehicle was made to run actually at the vehicle speed U in the test course B (“Measured Result”). As understood with reference to FIG. 7, “Conversion Result” and the “Measured Result” were satisfactorily in agreement with one another in all cases of the frequency spectra of vibrations of the vertical acceleration, longitudinal acceleration and lateral acceleration at the driver's seat. This suggests that a vibration level to be generated under an arbitrary road surface condition and/or vehicle speed condition can be estimated using transfer functions computed in accordance with the inventive vibration analysis technique.

### (d) In a Case of Using Unsprung Mass Vertical Acceleration Values as Vibration Input Values

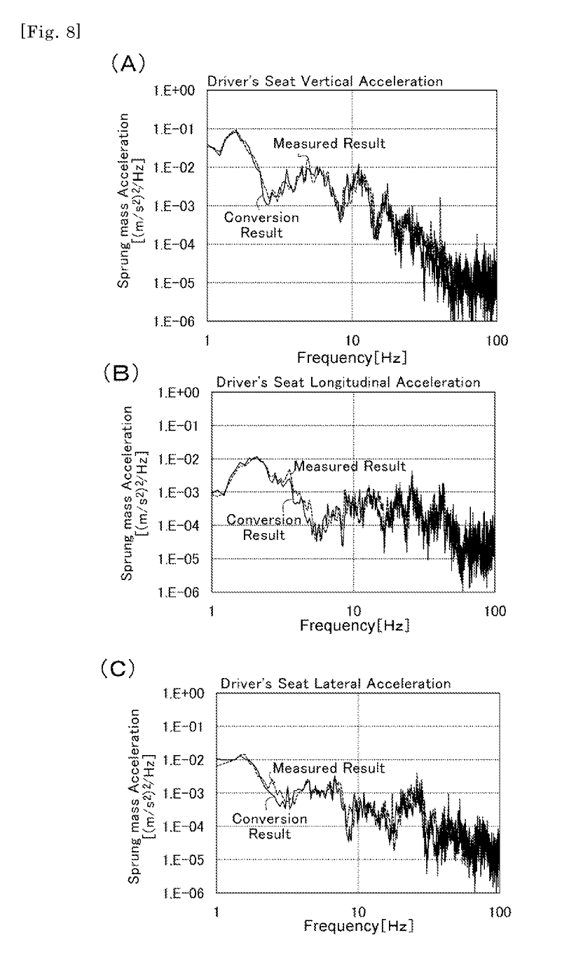

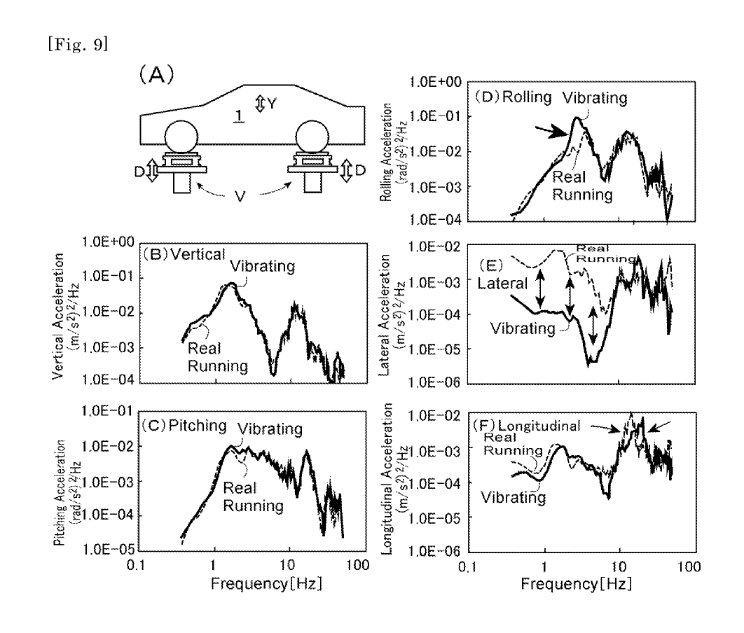

According to the inventive vibration analysis technique, transfer functions of vibrations in a vehicle body were computed using unsprung mass vertical acceleration values as vibration input values when a vehicle was made to run on a certain test course, and, using those transfer functions, vibration levels to be obtained when the vehicle would be made to run on the other road surface condition and vehicle speed condition were computed and compared with vibration levels actually obtained when the vehicle was made to run on the other road surface condition and vehicle speed condition. The transfer functions were computed with Expression (8) from the results of unsprung mass vertical acceleration values at respective wheels and sprung mass acceleration values obtained by performing the running of a vehicle at various vehicle speeds and vibration measurement in test course A. Then, vibration levels to be obtained in the running at a certain vehicle speed U in the other test course B were computed with Expression (10) using the computed transfer functions. FIG. 8 shows frequency spectra of vibrations of the vertical acceleration, longitudinal acceleration and lateral acceleration of a driver's seat to be obtained in the running at the vehicle speed U in test course B computed using the transfer functions obtained from the running of a vehicle and vibration measurement in the test course A according to the inventive vibration analysis technique (“Conversion Result”); and frequency spectra of vibrations of the vertical acceleration, longitudinal acceleration and lateral acceleration of the driver's seat obtained when the vehicle was made to run actually at the vehicle speed U in the test course B (“Measured Result”). As understood with reference to FIG. 8, “Conversion Result” and the “Measured Result” were satisfactorily in agreement with one another in all cases of the frequency spectra of vibrations of the vertical acceleration, longitudinal acceleration and lateral acceleration of the driver's seat. This suggests that a vibration level to be generated on an arbitrary road surface condition and/or vehicle speed condition can be estimated using transfer functions computed in accordance with the inventive vibration analysis technique, using unsprung mass vertical acceleration values at respective wheels as vibration input values.

Although the above explanations have been made with respect to embodiments of the present invention, it will be apparent for those skilled in the art that various modifications and changes are possible, and that the present invention is not limited to the above-illustrated embodiments and may be applied to various devices and apparatus without deviating from the concepts of the present invention.

1. A vibration analysis method of a vehicle, the method comprising steps of:
making the vehicle run on a road surface whose height varies at various wavelengths along a moving direction of the vehicle;
measuring a vibration characteristic value in a site of a vehicle body of the vehicle running on the road surface;
acquiring at least two vibration input values causing the vibration characteristic value in the site of the vehicle body; and
computing a transfer function of the vibration characteristic value in the site of the vehicle body for each of the at least two vibration input values as a partial regression coefficient by multiple regression analysis using the vibration characteristic value in the site of the vehicle body as a response variable and using the at least two vibration input value as explanatory variables.

2. The method of claim 1, wherein, in the step of making the vehicle run on a road surface whose height varies at various wavelengths along the moving direction of the vehicle, the vehicle is made to run at different vehicle speeds.

3. The method of claim 1, wherein the at least two vibration input values are functions of road surface displacements in respective wheels of the vehicle, and the vibration characteristic value in the site of the vehicle body is a sprung mass acceleration value or an unsprung mass acceleration value of the vehicle.

4. The method of claim 1, wherein the at least two vibration input values comprise a road surface displacement component varying in the same phase at left and right front wheels, a road surface displacement component varying in the same phase at left and right rear wheels, a road surface displacement component varying in the opposite phase at the left and right front wheels and a road surface displacement component varying in the opposite phase at the left and right rear wheels.

5. The method of claim 1, wherein the at least two vibration input values are unsprung mass acceleration values at respective wheels of the vehicle and the vibration characteristic value in the site of the vehicle body is a sprung mass acceleration of the vehicle.

6. The method of claim 1, further comprising a step of computing a vibration amplitude of the vibration characteristic value in the site of the vehicle body caused by one of the at least two vibration input values using the one of the at least two vibration input values and the corresponding transfer function.

7. The method of claim 1, further comprising a step of estimating, with the transfer functions, a vibration characteristic value in the site of the vehicle body to be obtained when the vehicle is made to run on a different road than the road surface on which the vehicle was made to run in conducting the measurement of the vibration characteristic value in the site of the vehicle body and the acquisition of the vibration input values used for the computation of the transfer functions.

8. The method of claim 1, further comprising a step of estimating, with the transfer functions, a vibration characteristic value in the site of the vehicle body to be obtained when the vehicle is made to run at a different vehicle speed than the vehicle speed at which the vehicle was made to run in conducting the measurement of the vibration characteristic value in the site of the vehicle body and the acquisition of the vibration input values used for the computation of the transfer functions.

9. The method of claim 1, wherein the road surface is a road surface whose height varies at random.

10. The method of claim 1, wherein the road surface is a road surface whose height varies stepwise.

11. A vibration analysis device of a vehicle, the device comprising:
a vibration characteristic value measurement portion which measures a vibration characteristic value in a site of a vehicle body of the vehicle during making the vehicle to run on a road surface whose height varies at various wavelengths along a moving direction of the vehicle;
a vibration input value acquisition portion which acquires at least two vibration input values causing the vibration characteristic value in the site of the vehicle body; and
a transfer function computation portion which computes a transfer function of the vibration characteristic value in the site of the vehicle body for each of the at least two vibration input values as a partial regression coefficient by multiple regression analysis using the vibration characteristic value in the site of the vehicle body as a response variable and using the at least two vibration input value as explanatory variables.
